(19) United States
(12) Patent Application Publication
(10) Pub. No.: US 2005/0078410 A1
(43) Pub. Date: Apr. 14, 2005

(54) Integrated magnetic head for magnetic recording and method for making same

(76) Inventors: Michael Fievre, Grenoble (FR); Jean-Baptiste Albertini, Grenoble (FR); Pierre Gaud, Coublevie (FR); Henri Sibuet, Le Fontanil (FR)

Correspondence Address: Robert E Krebs;Thelen Reid & Priest, P O Box 640640, San Jose, CA, 95123, US

(21) Appl. No.: 10/499,959

(22) PCT Filed: Dec. 24, 2002
(86) PCT No.: PCT/FR02/04556

(30) Foreign Application Priority Data
Dec. 28, 2001 (FR) 01/17013

(51) Int. Cl. G11B 5/187

(52) U.S. Cl. 360/122

(57) ABSTRACT

According to the invention, which applies in particular to helicoidal recording on tape, for example an integrated magnetic head comprising a thin layer structure whose portion which forms the reading and/or writing face of the head contains two polar parts (64, 66) separated by a gap (68) and longitudinally aligned, contained, in the direction transversal to the structure between two parallel planes (P1, P2) and in this portion, between the planes, on either side of the parts, at least one wear resistant material (70) is formed.

### TECHNICAL FIELD

This invention concerns an integrated magnetic head for magnetic recording as well as a manufacturing process for this integrated magnetic head.

In particular, this invention concerns integrated magnetic heads, manufactured by a thin layer technique, for helicoidal magnetic recording on tapes.

The invention mainly applies to general public or professional video (home VCRs, camcorders) as well as computer recording devices. Other fields of application are computer mass memories (micro-computers, work stations and large systems) and data storage on tapes or discs for other general public applications (multimedia, photo or audio for example).

### STATE OF THE PRIOR ART

The magnetic recording media designed for mass memories (video, audio or computer) comprise numerous tracks on which the information is written in the form of magnetic domains. To increase the density of the information, their number per surface unit is increased. To achieve this, the width of the tracks is reduced and, at the same time, the interval which separates these tracks, until the latter are joined, e.g. as in the helicoidal recording standard. This is diagrammatically illustrated by FIG. 1 in which the joined tracks 2 may be seen.

Preferably, two magnetic heads are used, whose azimuths are not nil and which are different from one another, to write and to read two joined tracks, in order to avoid crosstalk problems between the tracks. In the example shown in FIG. 1, these azimuths or slopes are respectively equal to +i and −i, where i is different to 0°. The bits are therefore written according to two opposed angles +i and −i.

The width of the final track is precisely defined in each standard (for example 6.7 μm in the systems called “DVC long play”.

The magnetic recording heads which concern this field that are currently available on sale are manufactured by micro-machining, and do not benefit from the advantages of collective manufacturing techniques that are used in micro-electronics.

However, the current reduction of the track width is leading to magnetic heads being manufactured that are of increasingly smaller dimensions. These dimensions are now reaching the limits of the micro-machining technique.

Another manufacturing technique is described in the following document to which we will refer:

(1) WO 92/02015, published on Feb. 6^{th}, 1992, “Manufacturing process for recording and/or reading heads for magnetic recording”, an invention of P. Gaud, H. Sibuet, A. Persico and L. Vieux Rochaz, see also U.S. Pat. No. 5,250,150 A.

This concerns a technique for manufacturing integrated magnetic heads preferably comprising an angled or azimuth gap.

It should be immediately pointed out that this invention provides improvements to the basic structure described in this document (1).

We will briefly make a reminder below, with reference to FIGS. 2 to 5, of an example of a process described in document (1).

FIG. 2 is a diagrammatical overhead view of a magnetic head 4 integrated into a chip 6 and whose two polar parts 8 and 9 are separated by an azimuthed gap 10.

The chip 6 is seen after being cut (which is to say after separation from the substrate in which it has been manufactured) and formatting of the contact surface 17 between the magnetic head and a magnetic recording medium (for example a tape).

In FIG. 2, we can also see the upper part 12 of the magnetic circuit of the head 4, as well as the coils 14 or solenoids, surrounding this upper part 12 of the magnetic circuit. In addition, we can see the rear closure 16 of the magnetic circuit.

This rear closure 16 is formed at the same time as the polar parts 8 and 9.

FIGS. 3, 4 and 5 are diagrammatic cross sectional views, only illustrating the main steps of the manufacturing process of the magnetic head 4 in accordance with the technique described in the document (1). In particular, the various levels of masking are not mentioned.

The cross sectional plane of FIGS. 3 to 5 has the reference A-A in FIG. 2. These figures respectively show the etching of the first housing of the first polar part (FIG. 3), the constitution of the gap and the positioning of the magnetic material of the first housing (FIG. 4) and the manufacture of the second polar part (FIG. 5).

More precisely, in the example considered, we wish to manufacture an integrated head in monocrystalline silicon, with a gap azimuthed at 20° with respect to the vertical plane. To achieve this, a monocrystalline silicon substrate 18 is used, orientated <115> and offset by 0.5°, in which anisotropic etching is performed to define the etching profile 20 and the cavity 22 or housing, that can be seen in FIG. 3.

It should however be noted that this principle may be used with any other monocrystalline substrate, which permits the slope angle or azimuth angle of the gap to be chosen.

The anisotropic etching is followed by thermal oxidation, which permits the gap 10 of the head (FIG. 4) to be formed. The thermal oxide layer (SiO₂) obtained has the reference 24. Once the gap is formed, the cavity 22 is filled with a magnetic material, whereby the first polar part 8 is formed. This magnetic material may possibly be layered to overcome the problems of eddy currents.

Selective isotropic etching is subsequently used (which, in the example in question, attacks the silicon but not the SiO₂) to form another cavity and this other cavity is filled with magnetic material as previously. The second polar part 9 (FIG. 5) is thus obtained, and is separated from the first polar part 8 by the azimuthed gap 10.

The most important point of the document (1) is the fabrication of the polar parts with an azimuthed gap. However, a head integrated onto silicon requires solenoids to be manufactured. This fabrication is resumed in FIGS. 6 to 11. The cross sectional plane of FIGS. 6 to 9 has the reference B-B in FIG. 2, and the cross sectional plane of FIGS. 10 and 11 has the reference C-C in this FIG. 2.

These FIGS. 6 to 11 respectively show the etching of the housing of the lower coil, it being filled by SiO₂ and then its planarisation (FIG. 6), the positioning of the lower coil by etching and the planarised deposition of a metal, for example copper (FIG. 7), the positioning of an insulating layer between the lower coil and the upper part of the magnetic circuit (FIG. 8), the positioning of the upper part of the magnetic circuit and the insulation with the upper coil (FIG. 9), the formation of electrical connections between the lower coils and upper coils, by filling with copper, depositing then planarisation (FIG. 10), and the positioning of the upper coil (FIG. 11).

More precisely, the first step of the manufacture of the coils or solenoids consists in etching a housing in the silicon substrate 16 (FIG. 6). This housing is designed to accommodate the lower coil or lower level of coil. This housing is therefore filled with an electrically insulating material 26, which in this case may be SiO₂. It is filled by depositing then planarisation. In FIG. 6, we can also see the polar part 8 and the rear closure 16 of the magnetic circuit.

Then, in the housing 26 which is thus filled, the housings designed to accommodate the lower level of coils (FIG. 7) are etched. These housings are filled by depositing copper then planarisation. The lower level of the copper conductors of the head coil is thus obtained.

An electrically insulated layer 30, for example SiO₂, is then deposited on the assembly thus obtained (FIG. 8) to form electrical insulation between the lower coil level (the copper wires or conductors) and the upper part of the magnetic circuit.

This insulating layer is necessary as the upper part of the magnetic circuit, which will finally be surrounded by the solenoid, is composed of an electrically conductive magnetic material.

Then, a new electrically insulating layer 32 made of SiO₂ is then deposited (FIG. 9), in which, with the help of deposits and planarisations, the upper part 34 of the magnetic circuit is positioned. This assembly is then covered with an electrically insulating layer 36 made of SiO₂ which is used to isolate the magnetic circuit from the upper part of the coil.

Then, with the help of etchings, deposits and planarisations, copper electrical connections 38 are formed (FIG. 10) to bring the electrical contact to the surface. Then, as can be seen in FIG. 11, a new deposit 40 of SiO₂, followed by an etching, a deposit and then a planarisation, permits the upper coil level 42 to be positioned.

The technique described by the document (1) presents disadvantages.

Monocrystalline silicon is used in this technique to obtain the azimuth chosen for the gap. However, the mechanical properties of monocrystalline silicon are inadequate for a practical use of the magnetic heads which result. The rate of wear of silicon is in fact too high.

We therefore try to replace this material in the contact zone 17 (FIG. 2) between the magnetic head and the magnetic recording medium (for example a tape) on which we wish to read or write information with this magnetic head.

We will also refer to the following document:

(2) French patent application No. 0003635 dated Mar. 22^{nd}, 2000, “Integrated magnetic head for helicoidal magnetic recording on tapes and its manufacturing process”, an invention of M. Fièvre, J. B. Albertini, P. Gaud and H. Sibuet, see also the international application PCT/FR 01/00840 dated Mar. 21^{st}, 2001.

This document describes the use of SOI (silicon on insulator) structures to manufacture integrated magnetic heads and proposes a solution to replace the silicon, above and beneath the gap, by a harder material such as Al₂O₃-TiC for example, as shown in FIG. 12A.

However, even using this solution, there is still silicon around the gap in the contact zone, as is also shown in FIG. 12A.

It should be noted that this FIG. 12A shows a magnetic head comprising a stack of layers, so that the words “above”, “beneath” and “around”, used above have a meaning.

In this FIG. 12A, we can see a magnetic head comprising a lower substrate 43 made of a material that is harder than silicon, a layer 44 for example made of SiO₂, a gap 46 included between the first and second polar parts 48 and 50, a layer 52, containing the upper part of the magnetic circuit and the coil which surrounds this circuit, and a super stratum 54 which can be made of the same material as the substrate 43. The residual silicon has the reference 56.

FIG. 12B shows a part of FIG. 12A and diagrammatically illustrates the general definition of two planes P1 and P2. These planes P1 and P2 are parallel planes, containing the polar parts 48 and 50 of the magnetic head, and are defined by the points A and B that may be seen in FIG. 12B. These points A and B define the part of the plane 46, common to the contour of the two polar parts 48 and 50. This part of the plane 46 is the gap of the magnetic head.

### DESCRIPTION OF THE INVENTION

The objective of this invention is to overcome the preceding disadvantages.

In particular, the invention proposes an integrated magnetic head, with a thin layer structure, in the contact zone in which a material harder than silicon replaces the latter around the gap and, preferably, also above and beneath this gap, as well as a manufacturing process for this magnetic head.

More precisely, this invention concerns an integrated magnetic head comprising a thin layer structure containing, in the portion of the structure constituting the reading and/or writing face of the magnetic head, two polar parts separated by a gap and longitudinally aligned, these polar parts have the specific characteristic of being surrounded, in the direction of the feed of a magnetic recording medium, by two zones of material with greater wear resistance than silicon.

According to one specific embodiment of the integrated magnetic head which is the subject of the invention, the polar parts are contained between two parallel planes of the thin layer structure, this structure comprising at least between these two parallel planes on either side of the polar parts in the direction of the feed of the magnetic recording medium, a material with higher wear resistance than silicon.

This invention also concerns an integrated magnetic head comprising a thin layer structure, this thin layer structure containing, in the portion of the structure constituting the reading and/or writing face of the magnetic head, two polar parts separated by a gap and longitudinally aligned, these polar parts being contained, in the transversal direction with respect to the structure, between two parallel planes of the thin layer structure, this magnetic head being characterised in that it comprises, at least in this portion, between the two parallel planes, on either side of the polar parts separated by the gap, a first material R1 that is more wear resistant, this first material being, for example, harder than the material of the housing, in order to increase the wear resistance of the reading and/or writing face (reference 17 in FIG. 2).

In the invention, the gap may be straight, which is to say without an azimuth, but this gap is preferably azimuthed, which is to say sloped, for the reasons mentioned above.

In preference, the magnetic head which is the subject of this invention also comprises two layers of a second wear resistant material R2, this second material being for example harder than silicon, and the two layers surround the thin layer structure, to increase further the wear resistance of the reading and/or writing face.

The combination of the R1 and R2 materials may be chosen in order to conserve a transversal radius with respect to the face 17, sufficiently small to ensure optimal contact of the poles next to the gap, whilst avoiding the flattening phenomenon inherent to the wear of the heads (for example, we could choose R1 to be more wear resistant than R2).

The choice of the second material could be made with respect to the material with the reference 70 in FIG. 15 of the appended diagrams, to control the transversal radius of the head during the wear process.

The magnetic head which is the subject of the invention may also comprise a layer shaped element containing additional circuits of the magnetic head, between the thin layer structure and one of the two layers of the second wear resistant material.

The first wear resistant material R1 may be chosen for example from Al₂O₃ and SiO₂.

The second wear resistant material R2 may be chosen for example from Al₂O₃— TiC, CaTiO₃, ZrO₂, Al₂O₂—SiC, sapphire, SiC or Si₃N₄.

According to one specific embodiment of the invention, the magnetic head comprises a main layer which surrounds the active part of the magnetic head, two intermediate layers surrounding this main layer and two auxiliary layers that are made from a material that is less wear resistant than the material of the main layer and which surrounds the two intermediate layers, these intermediate layers being made from a material that is less wear resistant than the material of the auxiliary layers, in order to form a structure capable of permitting a good contact between the head and a magnetic recording medium during the entire life of this head.

This invention also concerns a manufacturing process of an integrated magnetic head, a process in which a thin layer structure is formed containing, in the portion of the structure constituting the reading and/or writing face of the magnetic head, two polar parts separated by a gap and longitudinally aligned, these polar parts have the specific characteristic of being surrounded, in the direction of the feed of a magnetic recording medium, by two zones of a material that is more wear resistant than silicon.

According to one specific embodiment of this process, the polar parts are contained between two parallel planes of the thin layer structure, this structure comprising, at least between these two parallel planes on either side of the polar parts in the direction of the feed of a magnetic recording medium, a material that is more wear resistant than silicon.

This invention also concerns a manufacturing process of at least one integrated magnetic head, this process comprising the following steps:
a first substrate is formed comprising the first and second polar parts, the gap being preferably azimuthed, separating these first and second polar parts, and an element forming a rear closure of the magnetic circuit,
a first housing is formed in a substrate, around the first and second polar parts separated by the gap,
this first housing is filled with the first material R1 with the higher wear resistance, for example harder than silicon,
this first wear resistant material is planarised,
the magnetic circuit is completed, in order to obtain a closed magnetic circuit, incorporating the first and second polar parts, the gap and the element forming the rear closure of the magnetic circuit,
the coils of the magnetic head are formed, and
the magnetic head is cut transversally in order to separate it from the first substrate and reveal the reading and/or writing face of the magnetic head.

According to one specific embodiment of the process of the invention, the first wear resistant material R1 is SiO₂.

In this case, according to one preferred embodiment of the process of the invention,
in the first substrate, the first housing and a second housing permitting the coils of the magnetic head to be formed, are formed simultaneously
these first and second housings are filled simultaneously with the first wear resistant material, and
the first material filling the first housing and the first material filling the second housing are planarised simultaneously.

According to one specific embodiment of the invention, the first substrate comprises an auxiliary substrate, an etching stop layer on this auxiliary substrate and a thin layer of a monocrystalline material, with a suitable orientation, on the etching stop layer, and in this thin layer, by etching of it, the first and second polar parts, the gap and the first housing are formed.

In preference, the auxiliary substrate is made of silicon, the stop layer made of SiO₂, and the thin layer is made of monocrystalline silicon.

According to one specific embodiment of the invention,
the auxiliary substrate is eliminated to reveal the etching stop layer,
on the free face of the thin layer, another layer is fixed permitting the formation of the coils of the magnetic head to be completed,
on this other layer and on the etching stop layer, first and second layers of a second material that is more wear resistant than silicon, are respectively fixed and
the magnetic head is then cut transversally.

### BRIEF DESCRIPTION OF THE DRAWINGS

This invention will be easier to understand upon reading the description of the examples of embodiments provided hereunder, given purely by way of non restrictive example, with reference to the appended diagrams, in which:

FIG. 1 is a diagrammatical view of a known magnetic support medium, with joined tracks, and has already been described,

FIG. 2 is a diagrammatical overhead view of a known magnetic head, with an azimuthed gap, and has already been described,

FIGS. 3 to 5 are diagrammatical cross sectional views, illustrating the main steps of the manufacture of the magnetic head of FIG. 2, and have already been described,

FIGS. 6 to 11 are diagrammatical cross sectional views, illustrating the steps of manufacture of the solenoids of the magnetic head of FIG. 2, and have already been described,

FIG. 12A is a diagrammatical view of the contact zone of another known magnetic head, and has already been described,

FIG. 12B illustrates diagrammatically the definition of parallel planes containing the polar parts of a magnetic head and has already been described,

FIG. 13 is a diagrammatical view of the edge of a specific embodiment of the magnetic head of the invention in the process of being manufactured,

FIGS. 14 to 16 are overhead diagrammatical views illustrating steps of a process for manufacturing the magnetic head of FIG. 13,

FIGS. 17 and 18 are overhead diagrammatical views illustrating steps of a process for manufacturing the magnetic head of FIG. 13, in the case where silicon is used as the wear resistant material,

FIG. 19 is an overhead diagrammatical view of a magnetic head according to the invention, in the process of being manufactured,

FIGS. 20 to 22 are diagrammatical cross sectional views, illustrating manufacturing steps of the magnetic head of FIG. 19,

FIG. 23 is a diagrammatical view of the contact zone of another specific embodiment of the magnetic head of the invention,

FIG. 24 is an overhead diagrammatical view of an example of a magnetic head according to the invention,

FIG. 25 is a diagrammatical cross sectional view of this example before the solenoids of this magnetic head are manufactured, and

FIG. 26 diagrammatically illustrates another example of magnetic head according to the invention.

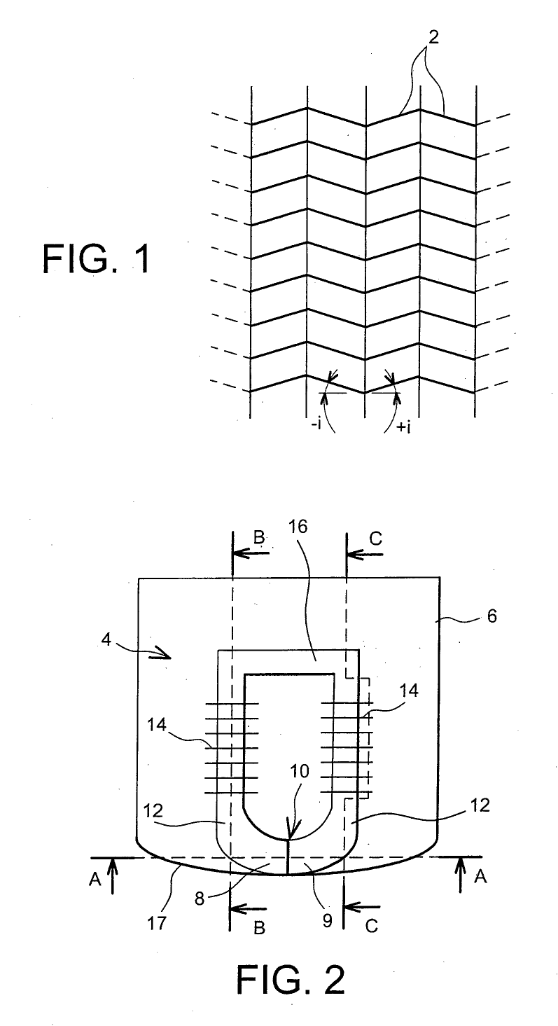

### DETAILED DESCRIPTION OF THE SPECIFIC EMBODIMENTS

In the following description, the materials are provided by way of example.

FIG. 13 is a diagrammatical view of an integrated magnetic head according to the invention in the process of being manufactured.

The thin layer structure 58, represented in this figure is seen on the edge of a chip, comprising the head in the process of being manufactured or on the edge of a wafer, comprising a large number of such magnetic heads being manufactured collectively.

The structure 58 is a view at the level of the reading and/or writing face of the magnetic head, this face being designed to be in contact with a magnetic recording medium (face 17, FIG. 2).

The structure 58 is formed on a thin layer 60 of silicon, acting as the etching stop layer and formed on a substrate 62, for example made of silicon or a wear resistant material (R2).

Between the plane P1 of the upper surface of the silicon layer 60 and another plane P2 parallel to P1, at the level of the reading and/or writing face and close to this face, the structure 58 comprises a first polar part 64 and a second polar part 66 which are separated by an azimuthed gap 68 made of silicon, and a wear resistant material 70 (R1), for example harder than silicon, on either side of the polar parts 64 and 66.

This material 70 is for example made of alumina or silica.

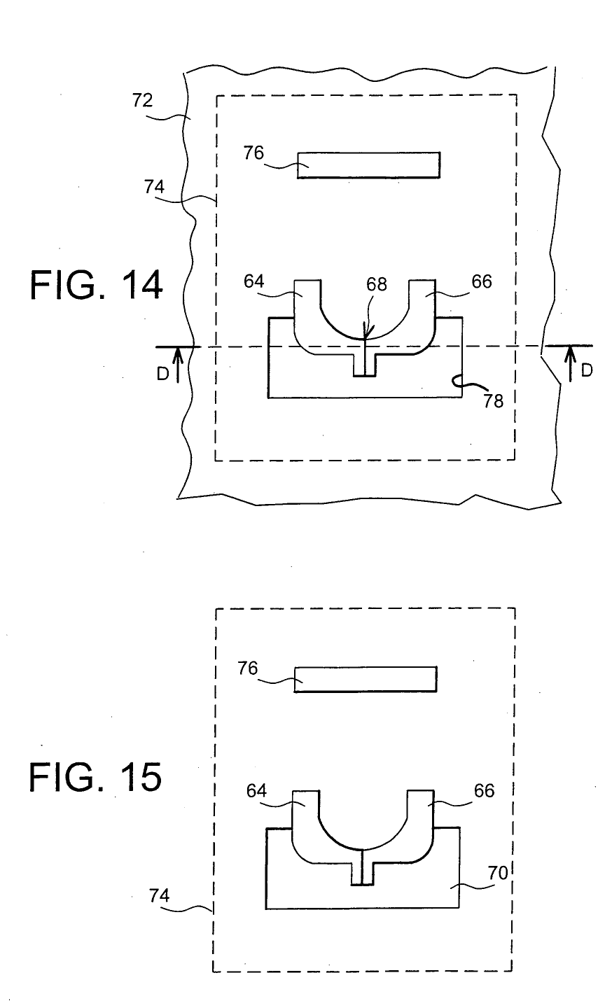

The structure of FIG. 13 is manufactured in large numbers on a wafer made of silicon or silicon type SOI on a wear resistant material reference 62 or 72, which is viewed from above in FIG. 14. The reference 74 represents the path for cutting out the chip containing the structure of the magnetic head in the process of being manufactured. FIG. 13 corresponds to the cross section D-D of FIG. 14.

For each chip, the two polar parts 64 and 66, separated by the gap 68 and an element 76 forming the rear closure of the magnetic circuit of the magnetic head corresponding to this chip, are manufactured first.

A housing 78 is then etched in the silicon of the wafer, around the polar parts 64 and 66, as shown in the overhead view of FIG. 14. Then this housing is filled with wear resistant material 70 (FIG. 15) by means of appropriate depositing of the material.

This material is then planarised to eliminate the excess (and to obtain the flat surface P2 of FIG. 13).

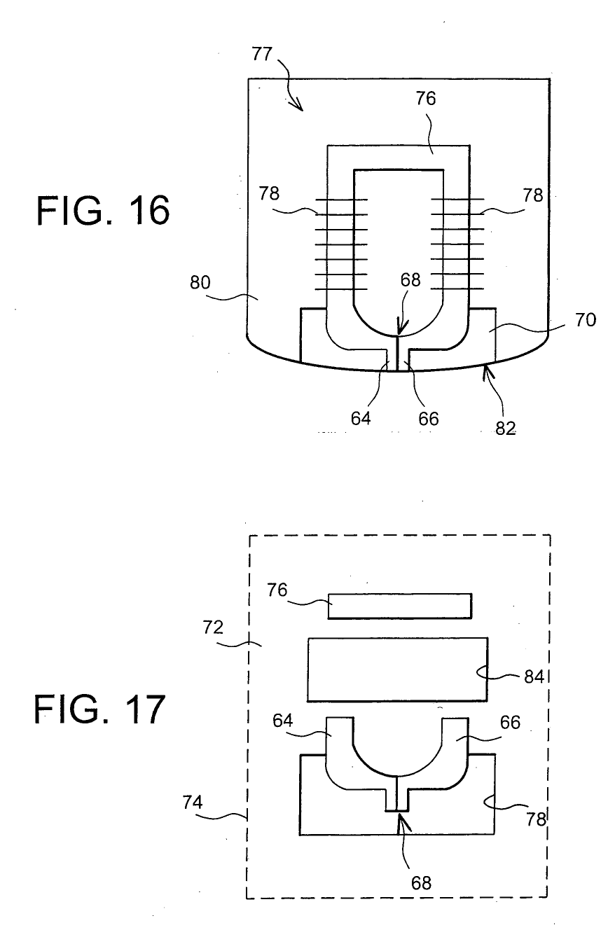

The magnetic circuit 77 of the magnetic head (FIG. 16) is then completed so that the circuit is closed (and for which the polar parts and the rear closing element have already been formed) and the coils 78 of the magnetic head are formed.

The chip 80 is then cut out and this chip is then formatted as can be seen in FIG. 16. In this way, the wear resistant material 70 is positioned around the polar parts, on the reading and/or writing face 82 of the magnetic head.

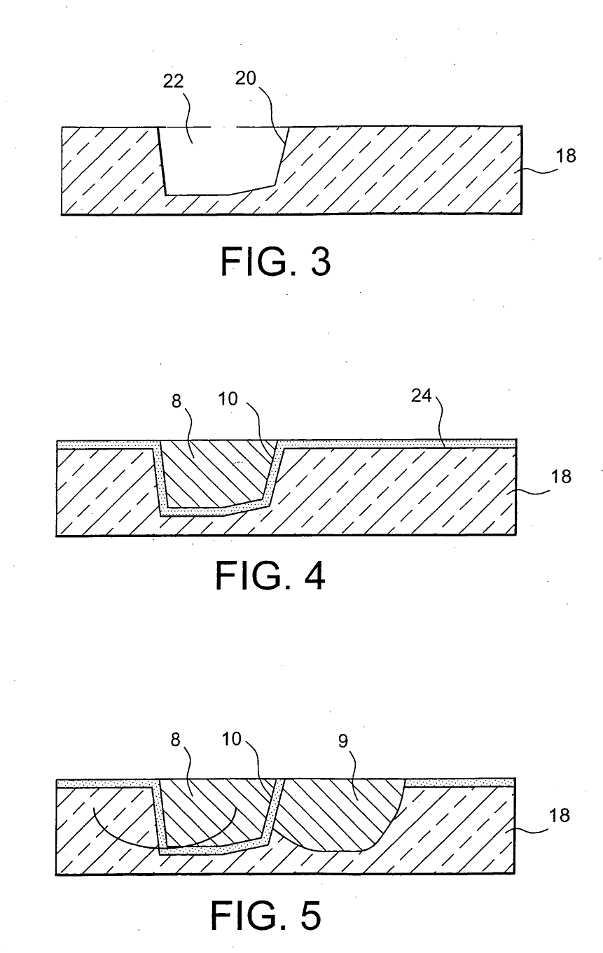

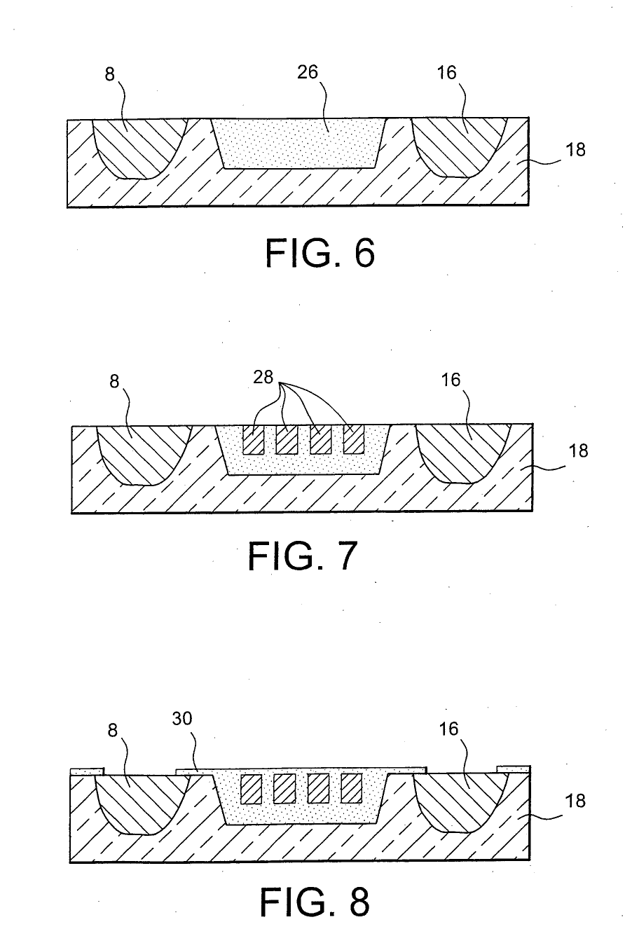

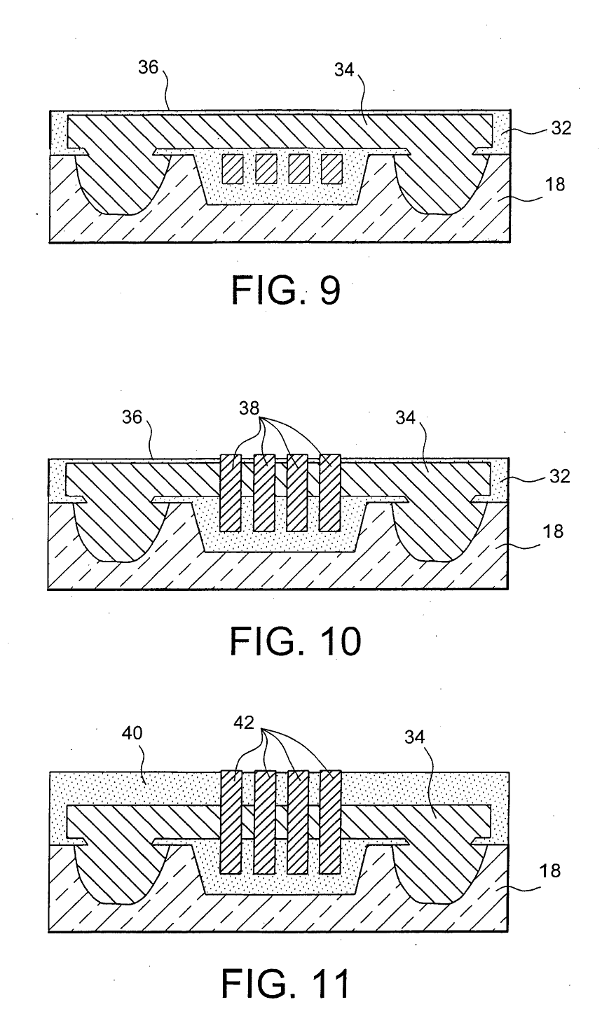

As concerns the manufacture of the polar parts 64 and 66, separated by the gap 68 and the element 76, the closing of the magnetic circuit 77 and the manufacture of the coils 78, we can refer to FIGS. 3 to 11 and the associated description.

In the example of FIGS. 17 to 19, we consider the use of silica as a wear resistant material 70. In this case, the etching operations of the silicon surrounding the polar parts 64 and 66, the depositing of silica in the housing 78 (FIG. 14) and the planarisation of the silica may be carried out at the same time as the corresponding operations concerning the lower coil housing 84 that may be seen in FIG. 17.

It should be noted that this technique has the advantage of resolving the problem of wear without adding extra technological steps.

More precisely, as can be seen in FIG. 17, among others, a zone 84 called the “lower coil housing” has been etched on the wafer 72 (FIG. 14), which is necessary to install the lower level of coil conductors, these conductors being made of copper for example.

This lower coil housing 84, which is not mentioned in the description of FIGS. 14 to 16, and which is not shown on these figures, is thus formed in addition to the polar parts separated by the gap and the rear closure element of the magnetic circuit.

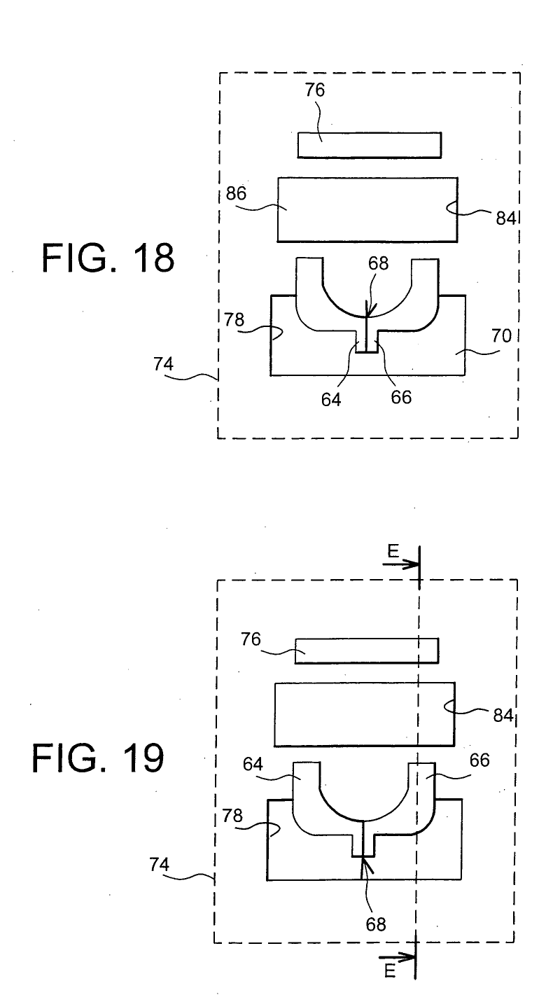

The housings 78 and 84 are etched at the same time as the silicon of the wafer 72. Then, silica 86 is deposited in the lower coil housing 84 (FIG. 18). The wear resistant material 70 is also deposited in the housing 78 surrounding the polar parts. If this material 70 is also silica, the two deposits are made at the same time and then they are subsequently planarised (the entire wafer 72 is planarised).

It should be pointed out that the lower coil level made of copper is then installed in the silica 86 used to fill the housing 84.

After completion and closure of the magnetic circuit and formation of the corresponding solenoids, each chip is cut out and formatted, as seen above.

The wear resistant material 70 is not necessarily silica: we have seen that it is possible to use alumina for example.

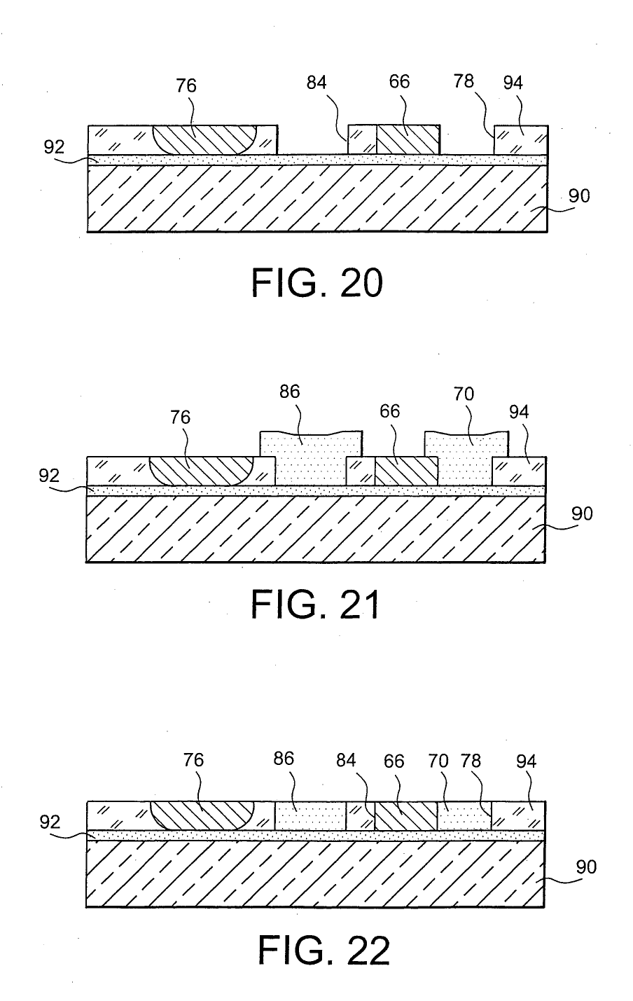

FIGS. 20, 21 and 22 are diagrammatical cross sectional views which illustrate the manufacturing steps of a magnetic head according to the invention and corresponding to this possibility. FIG. 19 is an overhead diagrammatical view showing this head being manufactured and the FIGS. 20 to 22 corresponding to the cross section E-E of FIG. 19.

In this FIG. 19, we can see, as previously, the path 74 for cutting out the chip containing the magnetic head. We can also see the polar parts 64 and 66, the gap 68 separating these polar parts, the rear closure 76 of the corresponding magnetic circuit, the corresponding lower coil circuit 84 and the housing 78 that is formed, as we have seen, around the polar parts 64 and 66.

In the case of the FIGS. 19 to 22, the isolating layer of an SOI (silicon on isolator) structure is used to stop the etching. The depositing and planarisation steps are carried out in the same way as previously described.

More precisely, we can see in FIG. 20 a silicon substrate 90, on which is formed a thin layer 92 made of silica, and a thin layer 94 made of monocrystalline silicon, which is formed on this layer of silica 92.

We can also see the polar part 66 and the rear closure of the magnetic circuit 76. Among others, we can see the lower coil housing 84 and the housing 78 formed around the polar parts, at the level of the contact zone or friction zone on the magnetic recording medium (for example the tape). The housings are etched into the silicon of the thin layer 94 and the silica layer 92 acts as the etching stop layer.

FIG. 21 shows the filling of the housing 78 by a wear resistant material 70, for example silicon or alumina, and the filling of the housing 94 with silica 86. FIG. 22 shows this material 70 and the silica 86 after planarisation.

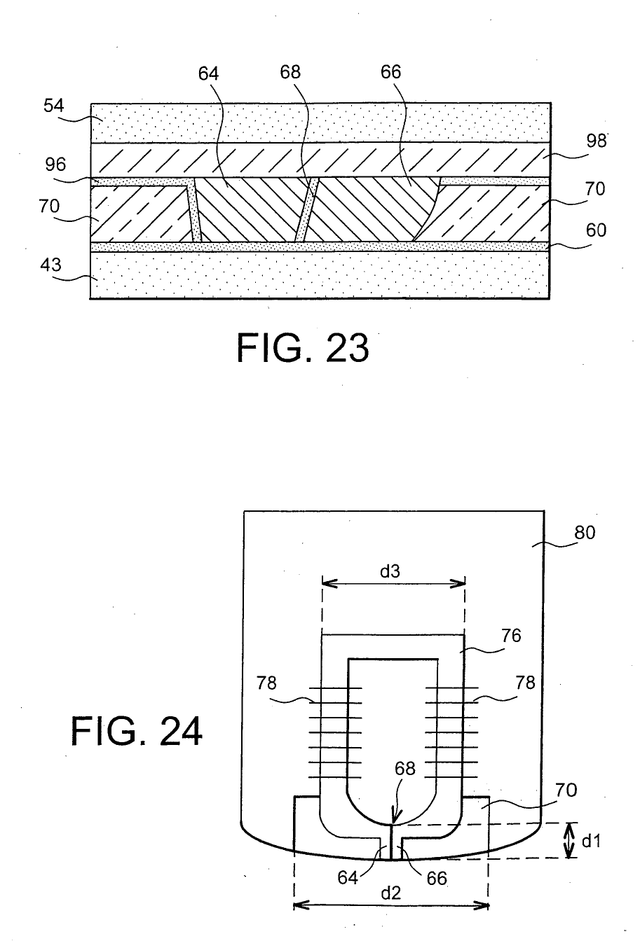

FIG. 23 is a diagrammatical view of another magnetic head according to the invention in the process of being manufactured.

More precisely, this other magnetic head comprises a structure an edge of which can be seen substantially at the level of the reading and/or writing face of the head.

The structure of FIG. 23 is to be compared with that of FIG. 13, and constitutes a more advanced step in the manufacturing process.

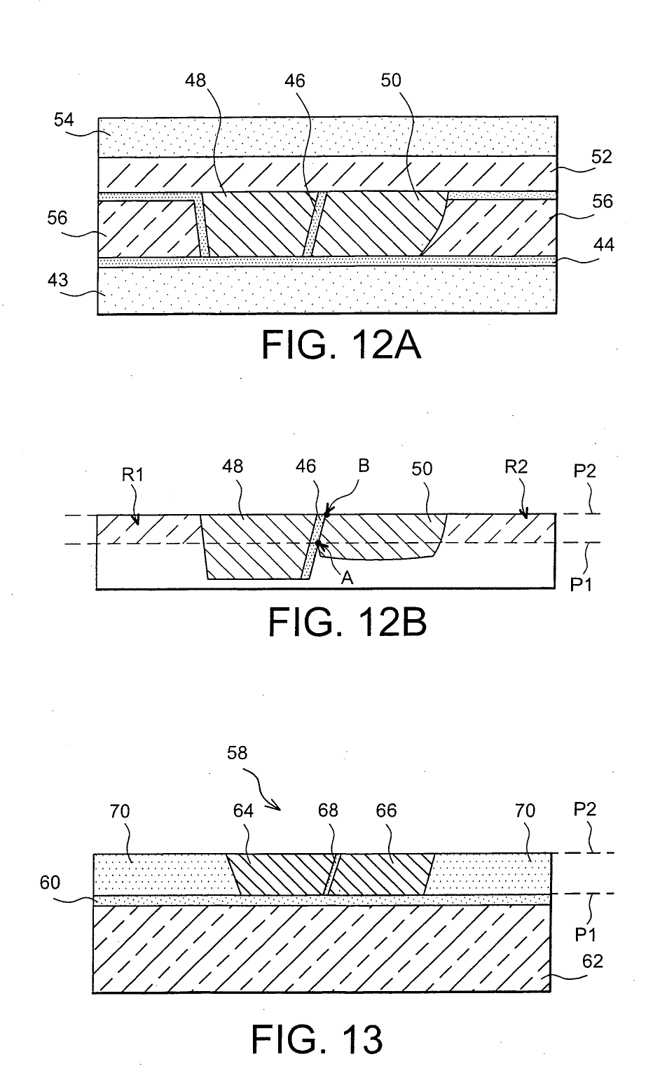

We will also compare it to the known structure in FIG. 12A, to which it provides, of course, improvements.

In fact, the structure that can be seen in this FIG. 23 combines the advantages provided by this invention and by the technique described in the document (2).

This structure of FIG. 23 permits all of the wear problems of the silicon to be resolved by replacing the latter everywhere at the level of the reading and/or writing face.

We can see on FIG. 23 the polar parts 64 and 66 separated by the azimuthed gap 68 made of silica and formed on a thin layer of silica 60, itself formed on a silicon substrate. We can also see on either side of the polar parts, the wear resistant material, 70, as explained in the description of FIG. 13, and a layer of silica 96 which covers this material 70, and also between the latter and the polar part 64.

A layer 98 is then fixed onto the silica layer 96, which contains the upper part of the magnetic circuit and the coil surrounding it.

The wear resistant substrate 54 is also fixed to this layer 98. The silicon substrate is then removed, which reveals the silica layer 60. Then the wear resistant substrate 43 is fixed to the silica layer 60. These substrates 43 and 54 are for example made of Al₂O₃—TiC, CaTiO₃ or ZrO₂.

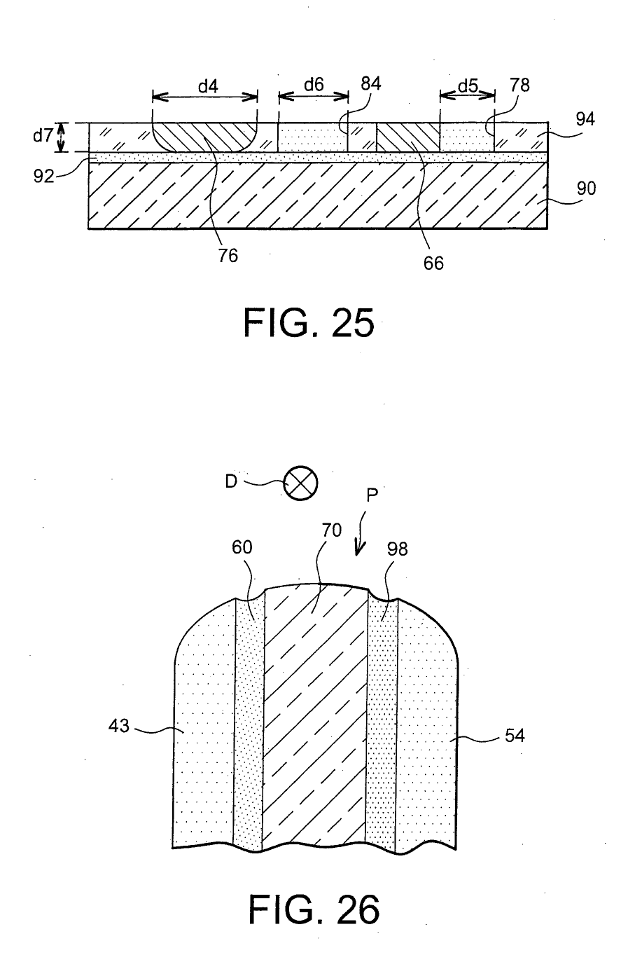

We will now provide, purely for information and in no way restrictively, a numerical example concerning a magnetic head according to the invention. FIG. 24 is an overhead diagrammatical view of this magnetic head whilst FIG. 25 is a diagrammatical cross sectional view of a stack of layers, obtained during the manufacture of this magnetic head, before the formation of the solenoids of the latter.

FIG. 24 (respectively 25) is to be compared with FIG. 16 (respectively 22) and, in FIGS. 16 to 24 (respectively 22 and 25), the same elements have the same references.

In the example of FIG. 24, the length d1 of the gap 68 (overhead view) is equal to around 10 μm, the length d3 of the rear closure 76 of the magnetic circuit (seen from above) is of the order of 250 μm and the width d2 of the housing of material 70 is of the order of 1 mm.

In the stack of FIG. 25, the width d4 of the rear closure 76 of the magnetic circuit is equal to around 100 μm, the width d5 of the housing 78 is equal to around 50 μm, the width d6 of the housing 84 is equal to around 200 μm and the thickness d7 of the layer 94 is equal to around 4 μm.

FIG. 26 is a diagrammatical view of another example of a magnetic head according to the invention. The profile P of this magnetic head can be seen and the direction D of the feed of a magnetic tape that is to be used with this magnetic head is also shown.

In the direction transversal to the feed of the tape, three materials of different hardness are located on either side of the active portion of the magnetic head (which is to say the polar parts plus all of the active portion of the functional elements of this head).

More precisely, a first layer 70 surrounds the active part of the head (this active part is inserted in the middle of the layer 70) and the material of which this layer 70 is composed is the hardest.

Two other layers 60 and 98 surround the layer 70 and are made of the softest material.

Two others 43 and 54 are located on the outside of the “sandwich” thus obtained (transversally to the direction of the tape feed). They surround the two layers 60 and 98 and are made from a material whose hardness is between that of the material of the layer 70 and that of the material of the layers 60 and 98.

The structure that may be seen in FIG. 26 is a “trimaran” type structure, and its form is suited to provide good contact between the head and tape during the entire life of the head.

The examples we have provided of the invention concern magnetic heads comprising an azimuthed gap. However, the invention is not restricted to such examples: it is also possible to manufacture, according to the invention, magnetic heads with a straight gap.

The technique of this invention offers the advantage of being able to choose the angle of the azimuth by choosing the crystalline orientation of the silicon. Another monocrystalline substrate apart from silicon may also possibly be used.

1. Integrated magnetic head comprising a thin layer structure containing, in the portion of the structure constituting the reading and/or writing face of the magnetic head, two polar parts (64, 66) separated by a gap (68) and aligned longitudinally, these polar parts having the specific characteristic of being surrounded, in the direction of the feed of a magnetic recording medium, by two zones of a first material with higher wear resistance than silicon.

2. Integrated magnetic head according to claim 1, in which the polar parts are contained between two parallel planes (P1, P2) of the thin layer structure, this structure comprising at least between these two parallel planes on either side of the polar parts in the direction of the feed of the magnetic recording medium, a first material that has higher wear resistance than silicon.

3. Integrated magnetic head comprising a thin layer structure according to claim 1, this thin layer structure containing, in the portion of the structure constituting the reading and/or writing face of the magnetic head, two polar parts (64, 66) separated by a gap (68) and aligned longitudinally, these polar parts being contained, transversally with respect to the structure, between two parallel planes (P1, P2) of the thin layer structure, this magnetic head being characterised in that it comprises, at least in this portion, between the two parallel planes, on either side of the polar parts separated by the gap, a first wear resistant material (70), in order to reinforce the wear resistance of the reading and/or writing face.

4. Integrated magnetic head of claim 1, in which the gap is an azimuthed gap (68).

5. Integrated magnetic head of claim 1, also comprising two layers (43, 54) of a second wear resistant material, the two layers surrounding the thin layer structure in order to increase further the wear resistance of the reading and/or writing face.

6. Integrated magnetic head of claim 5, also comprising an element (98) in the form of a layer containing additional circuits of the magnetic head between the thin layer structure and one (54) of the two layers of the second wear resistant material.

7. Integrated magnetic head of claim 5, in which the second wear resistant material is chosen from Al₂O₃—SiC, Al₂O₃— TiC, CaTiO₃, sapphire, SiC, Si₃N₄.

8. Integrated magnetic head of claim 1, in which the first wear resistant material (70) is chosen from Al₂O₃ and SiO₂.

9. Integrated magnetic head of claim 1, comprising a main layer (70) which surrounds the active part of the magnetic head, two intermediate layers (60, 98) surrounding this main layer (70) and two auxiliary layers (43, 54) that are made from a material that has lower wear resistance than the material of the main layer (70) and which surround the two intermediate layers (60, 98), these intermediate layers being made from a material with a lower wear resistance than the material of the auxiliary layers (43, 54), so as to form a structure capable of permitting a good contact between the head and a magnetic recording medium for the entire life of this head.

10. Manufacturing process of an integrated magnetic head, in which a thin layer structure is formed containing, in the portion of the structure constituting the reading and/or writing face of the magnetic head, two polar parts (64, 66) separated by a gap (68) and longitudinally aligned, these polar parts have the specific characteristic of being surrounded, in the direction of feed of a magnetic recording medium, by two zones of material that has higher wear resistance than silicon.

11. Process of claim 10, in which the polar parts are contained between two parallel planes (P1, P2) of the thin layer structure, this structure comprising at least between these two parallel planes on either side of the polar parts in the direction of feed of a magnetic recording medium, a material that has higher wear resistance than silicon.

12. Manufacturing process of at least one integrated magnetic head according of claim 1, this process comprising the following steps:
a first substrate is formed comprising the first and second polar parts (64, 66), the gap (68) being preferably azimuthed, separating these first and second polar parts, and an element (76) forming a rear closure of the magnetic circuit,
a first housing (78) is formed in a substrate, around the first and second polar parts separated by the gap,
this first housing is filled with the first wear resistant material (70),
this first wear resistant material is planarised,
the magnetic circuit (77) is completed, in order to obtain a closed magnetic circuit, incorporating the first and second polar parts, the gap and the element forming the rear closure of the magnetic circuit,
the coils (78) of the magnetic head are formed, and
the magnetic head is cut transversally in order to separate it from the first substrate and reveal the reading and/or writing face (82) of the magnetic head.

13. Process of claim 12, in which the first wear resistant material (70) is SiO₂.

14. Process of claim 13, in which
in the first substrate, the first housing (78) and a second housing (84) permitting the coils of the magnetic head to be formed, are formed simultaneously
these first and second housings are filled simultaneously with the first wear resistant material (70), and
the first material filling the first housing and the first material filling the second housing are planarised simultaneously.

15. Process of claim 12, in which the first substrate comprises an auxiliary substrate (90), an etching stop layer (92) on this auxiliary substrate and a thin layer (94) of a monocrystalline material of suitable orientation, on the etching stop layer, and the first and second polar parts, the gap and the first housing are formed in this thin layer by etching the latter.

16. Process of claim 15, in which the auxiliary substrate (90) is made of silicon, the stop layer (92) is made of SiO₂, and the thin layer (94) is made of monocrystalline silicon.

17. Process of claim 15, in which:
the auxiliary substrate is eliminated to reveal the etching stop layer,
on the free face of the thin layer, another layer (98) is fixed permitting the formation of the coils of the magnetic head to be completed,
on this other layer and on the etching stop layer, first and second layers (43, 54) of a second material that is more wear resistant than silicon are respectively fixed, and
the magnetic head is then cut transversally.
